(19) United States
(12) Patent Application Publication
(10) Pub. No.: US 2015/0049469 A1
(43) Pub. Date: Feb. 19, 2015

(54) High Efficiency Source of Artificial Lighting with Photovoltaic Feedback

(71) Applicants: Leonid Ekgaus, Trumbull, CT (US); Ilya Skuratovsky, Riverside, CT (US); Marina Bregman, Larchmont, NY (US)

(72) Inventors: Leonid Ekgaus, Trumbull, CT (US); Ilya Skuratovsky, Riverside, CT (US); Marina Bregman, Larchmont, NY (US)

(21) Appl. No.: 13/968,368

(22) Filed: Aug. 15, 2013

(51) Int. Cl. F21L 4/00

(52) U.S. Cl. CPC F21L 4/00
USPC 362/157

(57) ABSTRACT

The invention is a method for decreasing the energy consumption of artificial lighting fixtures by reducing the amount of fixtures required for a particular task. The invention consists of the application of photovoltaic cells to the parts of a lighting fixture not directly producing artificial light. The photovoltaic cells produce an electric current that powers a secondary artificial light source. The photovoltaic cells will convert light that would otherwise have been lost or absorbed by the parts of the lighting fixture. The secondary artificial light source is attached to the lighting fixture to the parts of the lighting fixture not directly producing artificial light. This secondary light source will produce light in addition to the primary light source.

### BACKGROUND OF THE INVENTION

1. Technical Field

The present invention relates generally to the field of electrical lighting, and more specifically to a method and apparatus for improving the efficiency of sources of artificial light using photovoltaic feedback.

2. Description of the Related Art

Conventional lighting fixtures have certain parts: a light emitting element and parts which are not directly used to create artificial light but used for the purpose of making light more concentrated or diffused, directing light, providing protection from glare, or for some other unspecified purpose not directly related to the light's energy output.

All of these parts of the lighting fixtures are useful, servicing their purpose but at the same time contributing to light loss, reducing the fixture efficiency and practically wasting energy.

### BRIEF SUMMARY OF THE INVENTION

Every known lighting fixture contain parts which are used for directing, aiming the light and transforming it into more comfortable for the required applications. Those parts are reflectors, diffusers, lens and etc. Some of the light is usually lost on these parts of the lighting fixture. In the present invention these parts or portions of these parts will be covered by photovoltaic panels. The photovoltaic panels can be spray on or plated. As soon as the lighting fixture will be switched on the photovoltaic panels will convert some of the light into electric current. Additional sources of light built in to the fixture (LEDs will more likely be used) will transfer the generated current into additional light. The fixture will become more efficient and energy will be saved.

### BRIEF DESCRIPTION OF THE SEVERAL VIEWS OF THE DRAWING

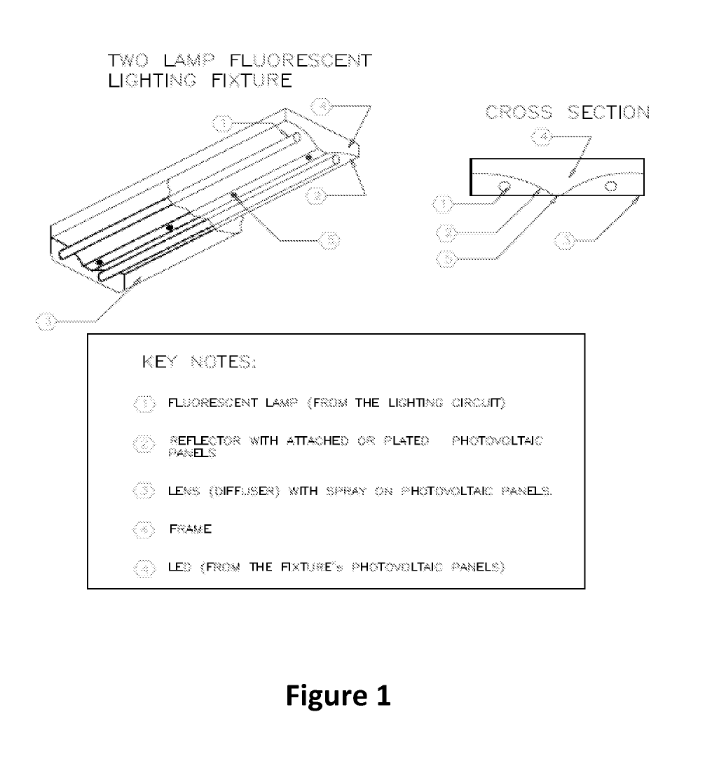

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figure. The figure (notated as FIG. 1) describes a configuration for a prototypical lighting fixture illustrating the method and apparatus embodied in the present invention.

### DETAILED DESCRIPTION OF THE INVENTION

Every known lighting fixture or other source of artificial lighting contains parts not directly involved in creating of artificial light by lamps but used for directing, aiming the light and making the light more comfortable for the required applications. These parts are reflectors, diffusers, lens, frame, etc. The frame of the lighting fixture is also considered a part for the purpose of the present invention. All of these parts of the lighting fixtures are useful, servicing the purpose but at the same time contributing to light loss, reducing the fixture efficiency and practically wasting energy.

The goal of this invention is to collect some of this lost light, convert it into photovoltaic electricity and use the generated electricity to create additional light by using additional electric lamps (LEDs are the more likely source of light). In our case all or some of the parts not directly involved in generating light (without losing their functionality) will be covered by photovoltaic panels. The photovoltaic panels can be sprayed, plated, or affixed in some manner. As soon as the lighting fixture will be switched on the photovoltaic panels will transfer some of the light into electric current. Additional sources of light built in to the same fixture will transfer that generated current into additional light. No batteries or switches are required. The second separate light emitting system is simple and independent. As long as the main lighting lamps are on, the photovoltaic system will be “on” and “off” when the main lamps will be off. The fixtures can be LED with additional LEDs, fluorescent with additional LEDs and so on. No additional work is required on the construction site. The light output will increase and the fixture will become more efficient using energy usually lost. Energy will be saved. The described method may be useful for any source of artificial lighting.

FIG. 1 shows an application of the invention using an example artificial lighting fixture. The example displayed is a prototypical fluorescent lighting fixture, however, the claims outlined in the present invention apply generally to all lighting fixtures.

Item 1 of FIG. 1 shows the primary light source for the example light fixture. The primary light source for the example light fixture are fluorescent bulbs.

Items 2-5 of FIG. 2 show examples of a lighting fixture's parts not directly involved in producing artificial light. These parts are reflector (Item 2), lens (Item 3), and frame (Item 4). Items 2-4 are known to those skilled in the art as typical parts of a lighting fixture that are not directly involved in producing artificial light.

Photovoltaic cells will be attached to parts of the lighting fixture not directly producing artificial light. In FIG. 1, photovoltaic cells are attached to the portions of the lens, reflector, and frame. The photovoltaic cells can completely cover or partially cover any and all parts of the lighting fixture not directly producing artificial light. The photovoltaic cells can be attached in a manner familiar to those skilled in the art including but not exclusively using an adhesive, mechanical fasteners, photovoltaic spray or photovoltaic plating.

Item 5 of FIG. 1 displays one possible configuration of the secondary light source(s) described by the present invention. Item 5 of Figure one shows LED's as the secondary light source. The LED's are attached to the lighting fixture's reflector. This is one possible configuration. The secondary light source can be attached to any part of the fixture as required by the lighting fixture's use. The LED's (secondary light source) can be attached using methods for attaching lighting sources familiar to those skilled in the art.

The photovoltaic cells and the secondary light source will be connected using an electrical connection known to those skilled in the art. The electric current generated by the photovoltaic cells will flow to the secondary light source. The current flowing from the photovoltaic cells will provide electrical power to the secondary light source (LED's in the example). The LED's will use the electrical power to produce artificial light. This light will add to the light output produced by the primary light source. This will enable the lighting fixture using the present invention to produce a higher output of artificial light at a given power level then an artificial light that is not using the present invention.

What is claimed is:

1. Application of photovoltaic cells to parts of an artificial lighting fixture not directly used for the purpose of light output. The photovoltaic cells are to be used for generating electrical current to power a secondary source of light

2. The photovoltaic cells in claim 1 and the secondary light source will be connected using an electrical connection.

3. Electric current from photovoltaic cells in claim 1 will flow to the secondary light source in claim 1. The secondary light source will use the electrical current to generate artificial light.

4. The photovoltaic cells can be attached in a manner familiar to those skilled in the art including but not exclusively using an adhesive, mechanical fasteners, photovoltaic spray or photovoltaic plating.

5. The lighting fixture from claim 1 can consist of the plurality of all possible electrical power based artificial lighting sources including incandescent, fluorescent, HID, LED, etc.

6. The secondary source of light from claim 1 can be in the form of LED's or other light source that requires an electrical current to operate.

7. The secondary source of light from claim 1 is affixed to the lighting fixture in any possible arrangement on the parts of the lighting fixture that are not directly producing artificial light.

8. The secondary light source from claim 1 will be affixed to parts that do not have photovoltaic cells.

9. The fixture parts from claim 1 can consist of any part of a lighting fixture not directly contributing to the output of artificial lights including but not exclusive to, diffusers, lenses, reflectors, and the fixture frame.

10. The current from the photovoltaic cells that is generated to power the secondary light source will be integrated into the on off mechanism of the lighting fixture in a manner that is known to those skilled in the art. When the lighting fixture is on, the secondary light source will also be on and when the lighting fixture is off the secondary light source will also be off.
